(19) United States
(12) Patent Application Publication
(10) Pub. No.: US 2014/0075037 A1
(43) Pub. Date: Mar. 13, 2014

(54) NETWORK STACK AND NETWORK ADDRESSING FOR MOBILE DEVICES

(71) Applicants: ROBERT M. COLE, Louisville, KY (US); PATRICK C. LANKSWERT, Prospect, KY (US); CHARLIE D. LENAHAN, New Albany, IN (US); CHRISTOPHER M. SONGER, Louisville, KY (US)

(72) Inventors: ROBERT M. COLE, Louisville, KY (US); PATRICK C. LANKSWERT, Prospect, KY (US); CHARLIE D. LENAHAN, New Albany, IN (US); CHRISTOPHER M. SONGER, Louisville, KY (US)

(21) Appl. No.: 13/725,565

(22) Filed: Dec. 21, 2012

Related U.S. Application Data
(60) Provisional application No. 61/700,287, filed on Sep. 12, 2012.

(51) Int. Cl. H04L 29/08

(52) U.S. Cl. CPC H04L 67/14
USPC 709/228

(57) ABSTRACT

An apparatus may include a processor circuit, a memory, and a networking stack for execution on the processor circuit to generate a request message to establish a communications session, the request message including a first globally unique identifier (GUID) that identifies the apparatus and second GUID associated with a target device, generate an application identifier that specifies a connection protocol to be used to conduct the communications session, and initiate the communications session upon receipt of the second GUID associated with the target device. Other embodiments are described and claimed.

### RELATED APPLICATIONS

This application claims priority to the commonly-owned co-pending provisional patent application U.S. Ser. No. 61/700,287, entitled “Network Stack and Network Addressing for Moving Devices” filed Sep. 12, 2012 (Docket No. P47542Z).

### BACKGROUND

Implementations of the claimed embodiments generally may relate to the field of mobile communications.

In the present day users often transport mobile devices between different locations while communications are active between the mobile device and another device or devices. As a mobile device moves between locations, its ability to communicate with other devices may change. In the present day, Internet Protocol (IP) addresses are used to identify most devices for the purposes of communicating with other devices across data networks. Typically an IP address is dynamically assigned to a mobile device and may change each time the mobile device connects to a network.

In one example, while deployed in a home setting, a mobile telephone and a tablet computing device may each have the ability to communicate over a common subnet of a wireless network. When transported to an automobile, however, the same two devices may lose connectivity as they move outside a communications range of the wireless network. In order to reestablish a communications link between the mobile telephone and tablet computing devices when deployed in a new location, each device may establish a link to an IP server device and link to one another based upon a supported application, which may be a cumbersome process. Alternatively, a link may be established using a local wireless protocol such as Bluetooth® or WiFi Direct®, each of which requires that both devices support such capability. In any event, an application that was supported by communications via the subnet between the tablet device and mobile phone may be disrupted before a new communications link is established.

Accordingly, it is common in the present day that a change in location of a mobile device may affect the ability to communicate with other devices and may therefore adversely impact the experience of the user of the mobile device. Users typically do not care how devices connect to one another, but simply want to perform desired tasks with other devices/users as well as to have tasks performed between their own devices. For example, the user may desire to play a game with another user, to stream a song from a home personal computer (PC) to the user's phone, or to ship photos between the user's phone and an ultrabook. In each of these activities, the user may desire that the activity continue working as the location of one or more of the user's mobile devices changes. Any disruption in communications with another device, such as that necessary to reestablish a connection via a different communications protocol or via a different communications path, may be unacceptable to the user depending on the type of activity the user is conducting.

Several approaches have been developed to address this problem. One solution entails fixing an external Internet Protocol (IP) address of a user's device by having the user's device establish connection via a virtual private network (VPN) to a server, which always acts as a proxy for the user's device. For example, a mobile telephone may transition from a subnet address 192.168.3.234 (outside a router 234.22.1.34) to a wide area network (WAN) address 10.12.13.14 to a different subnet address 192.168.213.2 (outside a router 111.222.2.3) while an address on the other side of the VPN server remains the same. This approach requires all devices to be linked to one another to communicate to maintain an online connection to a network and to be able to reach the VPN address. However, using this approach, as a user device moves between locations, dramatic changes in communication technology (for example, from an IP based transport to Bluetooth communication) may not successfully maintain communications between the user device and other devices.

Another approach entails a complex handoff process that operates on both a server and a client. An example of this latter approach is a scenario in which the client (user's device) runs a video streaming application that is receiving data from the server. In order to provide continuing video streaming content as the user's device moves between locations, an application running on the client (user's device) may negotiate with the server concerning network transitions needed to establish new connections and to resume using those new connections to provide the video streaming content. This consumes a significant amount of device and network resources, and often introduces communications latency and dropped connections.

Thus, in the foregoing conventional arrangements, complex approaches may limit the ability to maintain communications between two or more devices as each device is moved between locations. It is with respect to these and other considerations that the present improvements have been needed.

### BRIEF DESCRIPTION OF THE DRAWINGS

FIG. 1 illustrates an exemplary networking stack.

FIG. 2 illustrates a first instance of a scenario for communications consistent with the present embodiments.

FIG. 3 illustrates a second instance of the scenario for communications of FIG. 2.

FIG. 4 and FIG. 5 depict details of one scenario for conducting a communications session consistent with the present embodiments.

FIG. 6 depicts an exemplary second logic flow.

FIG. 7 depicts an exemplary second logic flow.

FIG. 8 depicts an exemplary third logic flow.

FIG. 9 depicts an exemplary system embodiment.

FIG. 10 depicts an exemplary system architecture.

### DETAILED DESCRIPTION

Embodiments of this disclosure provide novel approaches to networking that facilitate addressing for devices such as mobile devices. In particular, a networking stack is provided whose address space differs markedly from conventional networking stacks. In the present day, Internet Protocol (IP) addresses are use used to identify most devices for the purposes of communicating with other devices across data networks. Typically an IP address is dynamically assigned to a mobile device and may change each time the mobile device connects to a network. While conventional Internet Protocol (IP) employs addressing that is suitable for hierarchical routing, the present embodiments employ addressing techniques and architecture that describe, for example, users, devices, and applications. This enables mobile devices to seamlessly maintain connectivity at higher layers of the network protocol stack while changing connections at lower layers of the network protocol stack. As a result, the embodiments can improve affordability, scalability, modularity, extendibility, or interoperability for an operator, device or network.

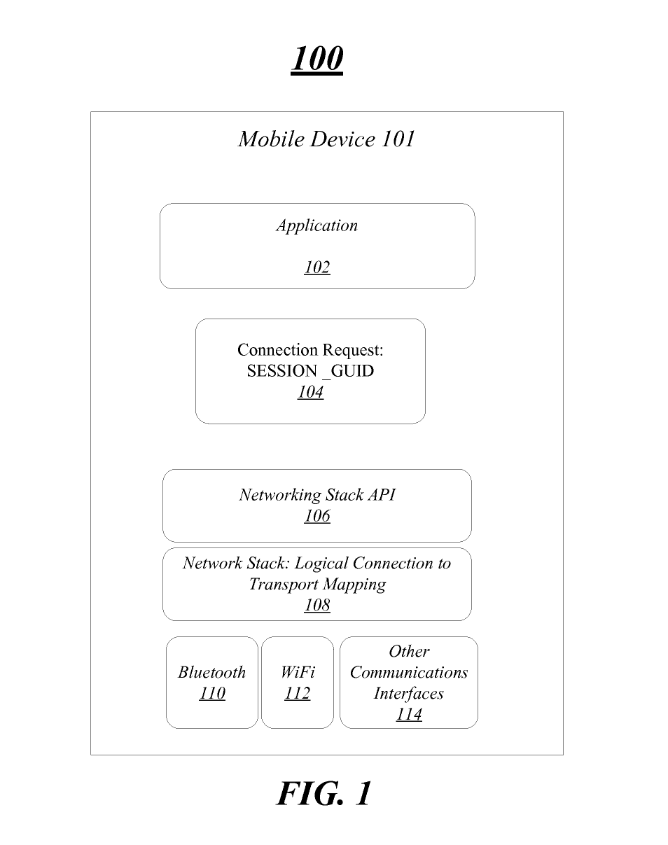

FIG. 1 illustrates an arrangement 100 that illustrates a mobile device 101 implementing a networking stack according to the present embodiments. In operation, a connection from the mobile device 101 to another device may be requested and accepted by supplying a session globally unique identifier (GUID) (e.g., SESSION_GUID) and an application GUID (e.g., APP_GUID) as a networking address. In particular, the SESSION_GUID is arranged to provide identification information for a specific user operating a specific device. The APP_GUID specifies identification information for an application that is to handle the other end of the connection, and more particularly, specifies a particular communications protocol to be used. In this regard, the exact bits of the application in question do not necessarily matter to the networking stack to maintain connectivity.

An advantage of this approach is that during communication between different devices, applications may establish and maintain a connection, that is, a communications link, that is not tied to a specific layer 2 (L2) networking protocol (e.g., an L2 network protocol of an open systems interconnect (OSI) model). Examples of L2 protocol include IEEE 802.11, IEEE 802.16, IEEE 802.3, point-to-point protocol (PPP), and so forth. Instead of tying the communications link to a specific L2 protocol, in the present embodiments the connection is tied to an end user, device and/or application. Because of this, the networking stack can employ different communications media and associated network interfaces (e.g., radios) to transport data communicated between different devices over the connection. Moreover, the networking stack can employ the different communications media to transport data without required knowledge of (or action from) the client or server applications.

Turning again to FIG. 1, the mobile device 101 may comprise or implement an application 102. The mobile device 101 may further comprise various computing and communications platform components, such as one or more processors, memory units, and wired or wireless network interfaces (not shown). In the example illustrated in FIG. 1, a connection request 104 for a SESSION_GUID (and/or APP_GUID) may be sent between the application 102 and networking stack application programming interface (API) 106. A logical connection to transport mapping 108 lies between the networking stack API 106 and various heterogeneous communication components, such as Bluetooth component 110, WiFi component 112, and other communications interfaces 114 (e.g., cellular communications components, WiMAX communications components, 3GPP long term evolution (LTE) and LTE Advanced communications components, etc.). A transport connection is a temporary logical connection that normally exists until one of the processes terminates the transport connection which carries a stream of two-way communications traffic between two processes on the same or different systems. The networking stack API 106 may utilize the logical connection to transport mapping 108 to initiate, maintain or modify a connection between the application 102 of the mobile device 101 and another application and/or device utilizing different communications technologies, including a Bluetooth connection via the Bluetooth component 110, a WiFi connection via the WiFi component 112, or some other communications interface 114. Changes in connection may occur seamlessly during a session identified by the SESSION_GUID with or without surfacing such changes to a user during the session. The embodiments are not limited in this context.

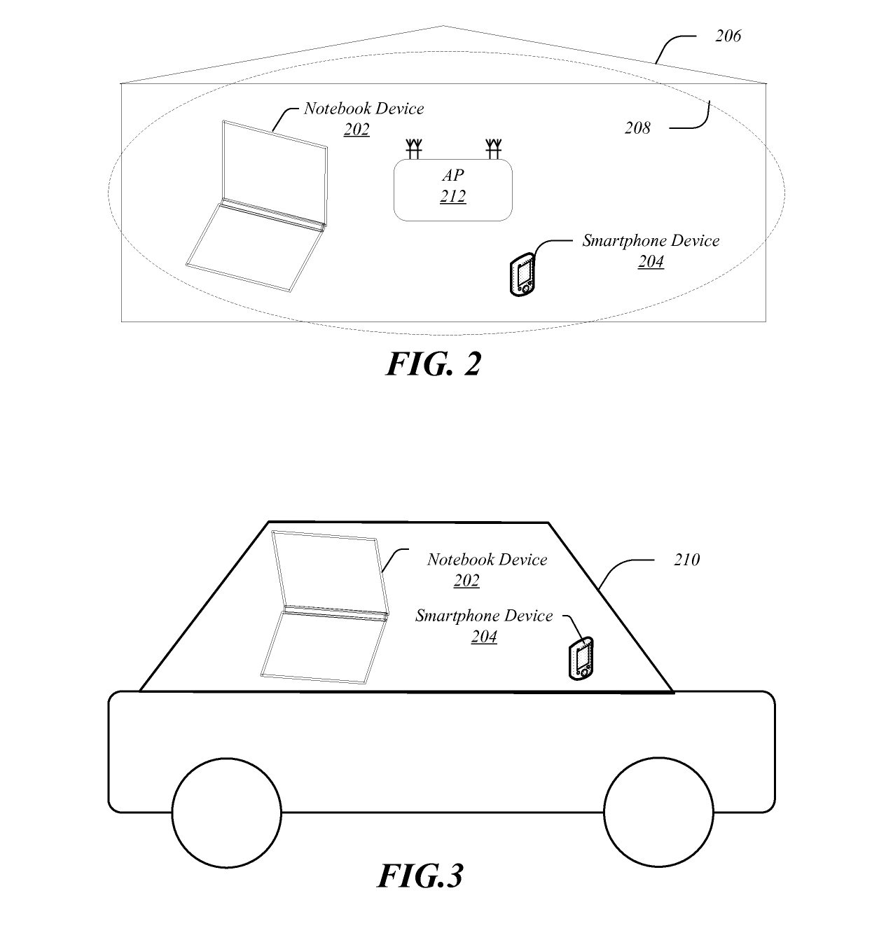

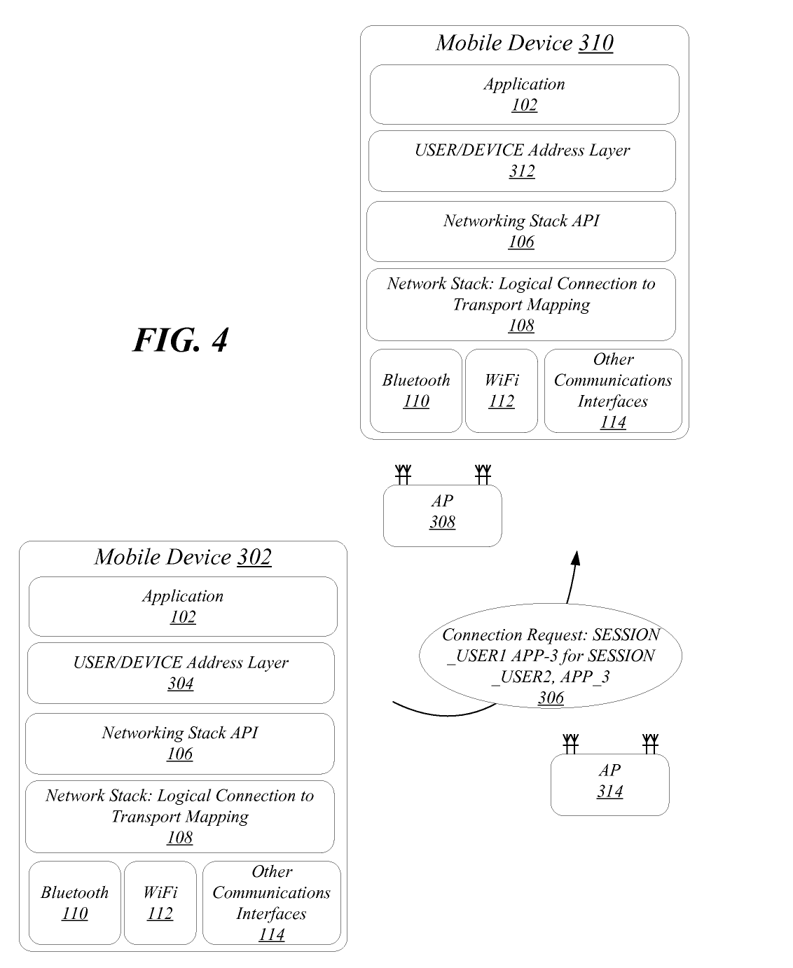

FIGS. 2 and 3 illustrate one scenario for communications consistent with the present embodiments. In this example, communications are maintained between a first device 202 and second device 204 when the location of one or more of the devices changes.

In some embodiments each or either of the devices 202 and 204 may be a mobile telephone, smartphone, tablet computing device, notebook computer, desktop computer, or other device generally capable of wireless communications. The embodiments are not limited in this context. In one example, the first device may be a notebook (computing) device 202 and the second device may be a smartphone device 204. In the scenario depicted in FIG. 2, a notebook device 202 and smartphone device 204 are both initially located in a home 206.

In various embodiments, either the notebook device 202 or smartphone device 204 may act as a source device (device 202, 204) to initiate a communications session with a target device (device 204, 202) as detailed below. For example, the notebook device 202 may request a connection to the smartphone device 204. Consistent with the present embodiments, a connection between the notebook device 202 and smartphone device 204 may be established and maintained in the following manner. The notebook device 202 and smartphone device 204 may each be linked within the home 206 to a subnet 208 (e.g., via an access point 212, which may be an IEEE 802.11 wireless access point for example). In order to establish a communication session the notebook device 202 may indicate a destination for a communications session address that specifies a specific user/device and application, which may identify the smartphone device 204 in the scenario of FIG. 2. In particular, the notebook device 202 and smartphone device 204 may communicatively link to one another when a “SESSION_{—}1 APP_{—}1” requests a connection to “SESSION_{—}2 for APP2.” A networking stack (see FIG. 1, for example) in the notebook device 202 may either unilaterally, or by negotiation with smartphone 204, provision an initial transport for the connection. In one instance generally illustrated in FIG. 2, the connection may be initiated over a subnet based IP because the two devices 202 and 204 are both linked to the same subnet 208 in home 206. In one particular example, the notebook device 202 may be a MICROSOFT® WINDOWS® based device, while the smartphone 204 is a GOOGLE® ANDROID® based phone. The embodiments, however, are not limited to these examples.

After a connection (e.g., a wireless communications link) is established between the notebook device 202 and smartphone device 204 in the home 206, the user may wish to transport both devices in an automobile while the connection is still active. As illustrated in FIG. 3, the notebook device 202 and smartphone device 204 may be subsequently physically carried to a user's automobile 210 where the subnet 208 in the home 206 is no longer valid due to the transport of notebook device 202 and smartphone device 204 outside of the communications range of the access point for the home subnet 208.

However, in accordance with the present embodiments, at the bottom end of the application and the top end of the networking stack, the connection that links the smartphone device 204 and the notebook device 202 is not, for example, established between different IP addresses (e.g., 192.168.234.3 port 4544 and 192.168.234.4 port 4544), but rather the connection is established between user 1 on device 1's app1 and userl on device2's app1. Accordingly, even though the transport between the notebook device 202 and the smartphone device 204 may drop as the notebook device 202 and the smartphone device 204 are transported out of the range of the subnet 208 within home 206, the networking stack (see FIG. 1) can keep the connection between notebook device 202 and the smartphone device 204 alive and subsequently re-provision the connection utilizing a different radio and/or communications medium. In one example, the notebook device 202 and the smartphone device 204 may be (re)connected over a Bluetooth link within the automobile 210 utilizing the SESSION_GUID and/or the APP_GUID identifiers originally exchanged to set up the communications session between the notebook device 202 and smartphone device 204 over the subnet 208.

In accordance with the present embodiments, the moving of the network address space to sessions and applications may support any type of transport. “Cloud” based transport, such as network address translation (NAT) traversing. NAT traversal or traversing generally refers to techniques that establish and maintain internet protocol connections traversing network address translation (NAT) gateways. Network address translation breaks end-to-end connectivity and is typically used for client-to-client networking applications, such as voice-over IP (VoIP) deployments. Other examples of cloud based transport facilitated by the present embodiments include peer to peer (P2P), traversal using relay NAT (TURN), IP based transports, which may be employed on behalf of an application. Moreover, the present embodiments provide the benefits that any mechanism by which electronic devices can exchange data can be used on behalf of the application without an application developer having to do any additional work to support these additional transports and without the application developer having to do any additional work to support transport transitions.

In accordance with various embodiments, the identification of user devices to take part in a communications session may be facilitated using a protocol such as transport layer security (TLS).

Transport Layer Security (TLS) is a cryptographic protocol that was developed to provide secure communications over the internet. In particular, TLS is an internet engineering task force (IETF) standard protocol based upon the earlier X.509 (referred to also as secured sockets layer (SSL)) protocol supported by the international telecommunications union (ITU).

In operation, TLS provides authentication between devices using X.509 certificates. In general, the role of an X.509 certificate is to associate a public key with the identity contained in the X.509 certificate. Cyrptographic systems typically employ two keys: a public key generally known to the world and a private key known only to the recipient of a message. When a first device is to send a secure message to a second device, the first device employs the public key of the second device to encrypt the message and the second device employs its private key to decrypt the message.

In particular, a TLS process may begin with a handshake during which a device such as a server is authenticated to a client (user) using X.509 certificates. The certificate contains information about a user, in addition to a unique private-public key pair. In some cases, the client may also be authenticated to the server. During the handshake, security session parameters, such as cryptographic algorithms, are negotiated and session keys are created.

In accordance with various embodiments, a first device may initiate a connection to a second device via a TLS process. In one instance, the first device may initiate a handshake during which a target device is authenticated to the first device using X.509 certificates. In the present day, X.509 certificates are typically employed by web browsers that support the TLS protocol. During this handshake process, the first device may be also authenticated to the target device using an X.509 certificate issued to the first device. The X.509 certificate may include, for example an identifier of the first device user such as a device user name. When a connection request message is generated an X.509 certificate may be presented to a message recipient (target device) by attaching the X.509 certificate directly to the message.

In some cases the target device may be an intermediary device such as a server, access point, or other device that may be linked to both the first device and second device. In other cases, the target device in the handshake process initiated by the first device may be the second device for which a connection is to be established. Thus, in some embodiments, both first device and second device may be supplied with X.509 certificates.

After the handshake process is complete, the first and second device may negotiate a transport for the session connection and data exchanged in the session may be protected.

In some embodiments, provisioning of a user device with an X.509 certificate may take place when the device initiates a certificate signing request or similar procedure. The user device may provide information that identifies the user to the certificate authority to provide the X.509 certificate. For example, a social identity associated with the user may be provided, such as a GOOGLE® ID or other identifier. In accordance with the present embodiments, multiple different devices may be provisioned with a certificate that identifies a user for connection via a TLS or SSL protocol.

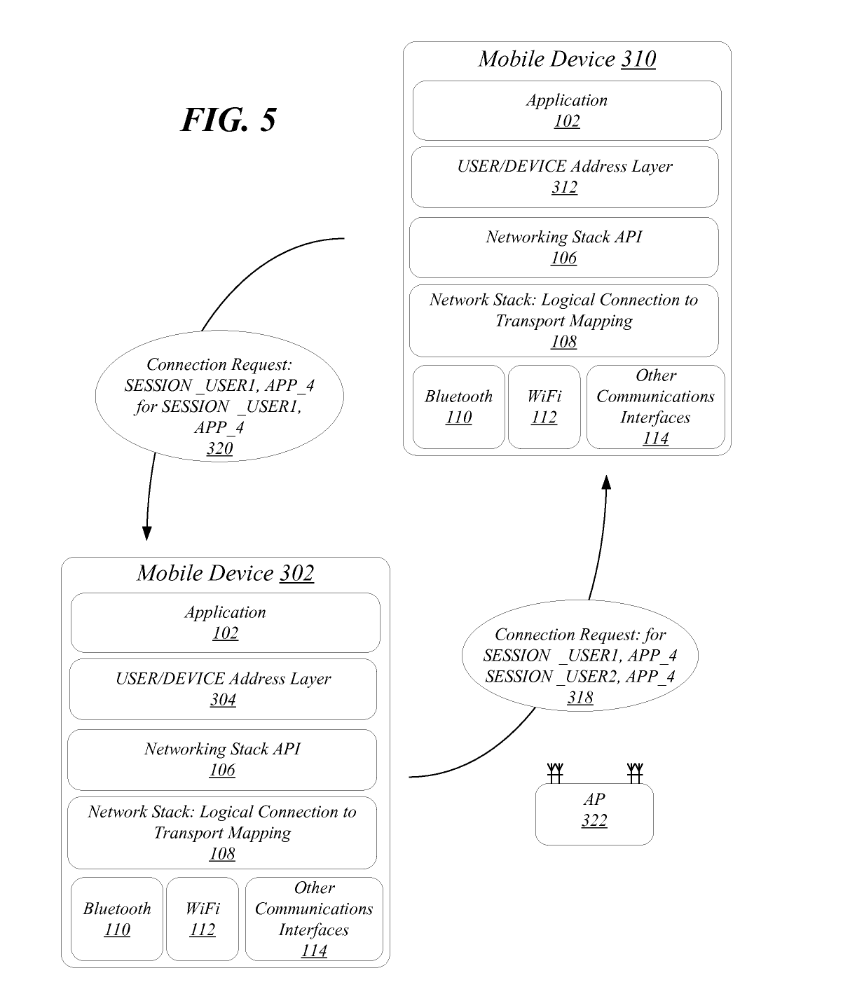

FIG. 4 and FIG. 5 depict details of one scenario for conducting a communications session consistent with the present embodiments. In this case, a user of the mobile device 302 may wish to link to the mobile device 310. In one example the mobile device 302 and 310 may each be under control of the same user. As further shown in FIG. 4, the first mobile device 302 and second mobile device 310 may be brought by the user to a location that is within a communications range separate wireless networks (not shown) that are provided by the respective access points 308, 314. Each of access point 308 and access point 314 may be capable of wirelessly coupling to each of the mobile devices 302, 310 in the instance shown in FIG. 4.

In one particular scenario, the first mobile device 302 and second mobile device 310 may wirelessly communicate with one another after the first mobile device 302 initiates a process to link to the second mobile device 310. The first mobile device may generate an exchange that includes the information identifying the first mobile device 302, second mobile device 310, and application to handle connection. In the example illustrated in FIG. 4, the information in a connection message 306 generated by mobile device 302 includes SESSION_USER1 APP-3 for SESSION_USER2, APP3, which identifies the networking address of the first mobile device 302 as well as that of the second mobile device 310. If the first mobile device 302 and second mobile device 310 include security certificates, such as an X.509 certificate, each mobile device 302, 310 may be authenticated via its respective certificate to provision a connection for the communications session between the first mobile device 302 and second mobile device 310.

In one example, after the connection message 306 is generated, a determination is made as to the possible mechanisms through which the mobile device 302 and 310 may communicate together. For example, the access point 308 may be an 802.11 access point and the connection message SESSION_USER1 APP-3 for SESSION_USER2, APP_{—}3 may indicate that the access point 308 can handle transport for the communications session. Subsequently, a wireless communications connection may be established between mobile device 302 and mobile device 310 to exchange data. For example, the communications session may commence when the mobile device 302 receives a message with a GUID such as “USER2” generated by the mobile device 310.

During the time that the mobile device 302 and mobile device 310 exchange information, a user may move the mobile device 302 and mobile device 310 to a new location that is outside of the communications range of the access point 308 as well as the access point 314. This instance is depicted in FIG. 5, where the mobile device 302 and mobile device 310 may be located near a new access point 322. At this point the user device/address layer 304 of mobile device 302 and user device/address layer 312 of mobile device 310 may both begin searching for a new connection to handle transport for the communications session. As shown in FIG. 5, the mobile device 302 generates a connection message 318: SESSION_USER1APP-4 for SESSION_USER2, APP_{—}4 while the mobile device 312 generates a connection message 320: SESSION_USER2 APP-4 for SESSION_USER1, APP_{—}4.

Subsequently, whichever of mobile devices 304, 312 wins the networking “race” may re-establish the communications session via the new transport, which may be over the wireless network provided by the access point 322. Notably, between the time that the wireless link between mobile devices 304, 310 that is carried by the access point 308 is severed and the time a wireless link between the mobile devices 304, 310 is reestablished via access point 322, the application 102 may not “know” that the connection has dropped. Therefore, the application 102 may act seamlessly to process an exchange of data between mobile devices 304, 310 between the instances illustrated in FIGS. 4 and 5 even though a physical wireless connection between mobile devices 304, 310 drops for a period of time.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

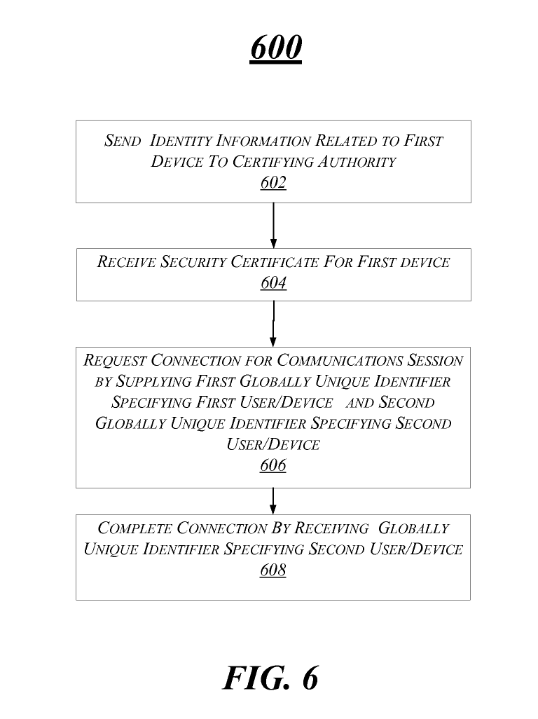

FIG. 6 depicts an exemplary first logic flow 600. The logic flow 600 may be implemented, for example, in a networking stack of a first device. At block 602 identity information for a first device is sent to a certifying authority. For example, a user of the notebook device 202 may transmit information for receiving an X.509 certificate from a certifying authority. The flow then proceeds to block 604.

At block 604 a first security certificate is received for a first device. The flow then proceeds to block 606.

At block 606 a connection is requested for a communications session by supplying a first globally unique identifier that specifies a first user/device and a second globally unique identifier that specifies a second user/device. In one example, a notebook device 202 may generate a message that specifies “SESSION_{—}1 APP_{—}1” requests a connection to “SESSION_{—}2 for APP2.” The flow then proceeds to block 608.

At block 608, the connection is completed by receiving a globally unique identifier specifying a second user/device.

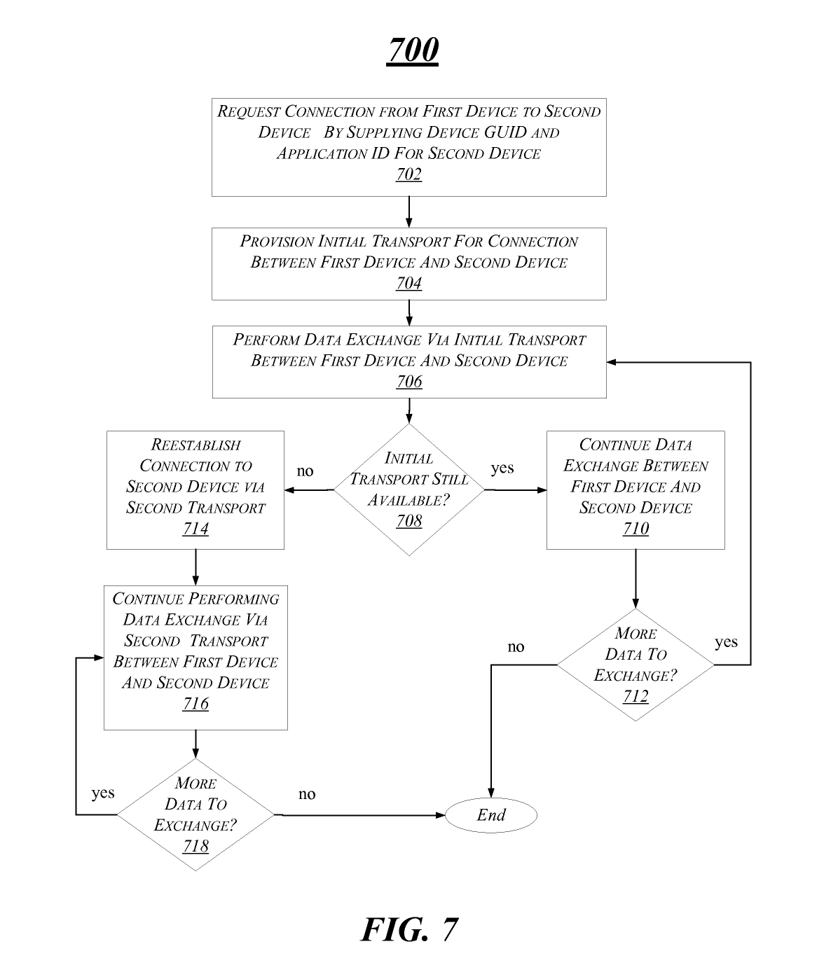

FIG. 7 depicts an exemplary second logic flow 700. At block 702 a connection is requested from a first device, for example, the notebook device 202, to a second device, for example, the smartphone device 204, by supplying a globally unique identifier and application identifier for the second device. The flow then proceeds to block 704.

At block 704, an initial transport for connection is provisioned between the first device and the second device. In one instance the initial transport may be specified by indicating an application when a connection is requested, such as SESSION_USER1 APP-3 for SESSION_USER2, APPS. The flow subsequently proceeds to the block 706.

At block 706 a data exchange is performed between the first device and the second device using the initially provisioned transport. The flow then proceeds to the block 708.

At block 708, a determination is made as to whether the initial transport is still available. If the initial transport is still available at block 708, the flow proceeds to block 710.

At block 710 data continues to be exchanged between the first device and second device via the initial transport. The flow subsequently proceeds to the block 712.

At the decision block 712, a determination is made as to whether more data is to be exchanged. If no further data is to be exchanged, the flow ends. If, at block 712 a determination is made that more data is to be exchanged, the flow returns to the block 706.

If, at block 708 a determination is made that the initial transport is no longer available, the flow proceeds to the block 714.

At block 714, the connection between the first device and the second device is reestablished via a second transport. In one instance, the second transport may be specified by indicating an application when a connection is requested, such as SESSION_USER1 APP-4 for SESSION_USER2, APP_{—}4.

The flow exchange is continued via the second transport between the first device and second device. The flow then proceeds to the decision block 718.

At block 718, a decision is made as to whether more data is to be exchanged. If no more data is to be exchanged, the flow ends. If, at block 718 a determination is made that further data is to be exchanged between the first and second device, the flow returns to block 716.

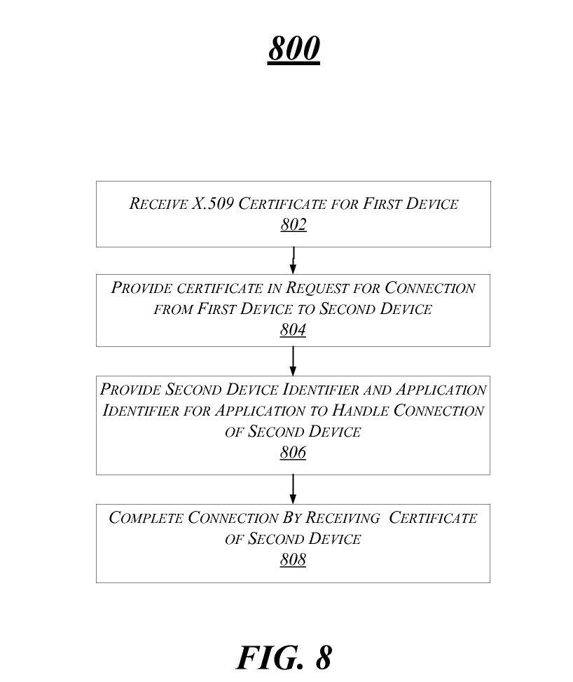

FIG. 8 depicts an exemplary third logic flow 800. At block 802, an X.509 certificate is received for a first device. For example, an X.509 certificate may be generated for the notebook device 202. The flow then proceeds to block 804.

At block 804, a certificate is provided in a request for connection from the first device to a second device. As one example, the notebook device 202 may provide an X.509 certificate in conjunction with a request to connect to the smartphone device 204. The flow subsequently proceeds to the block 806.

At block 806 an identifier for the second device and identifier for an application to handle the connection of the second device are provided. The flow then proceeds to the block 808.

At block 808, the connection between the first device and second device is completed by receiving a certificate of the second device.

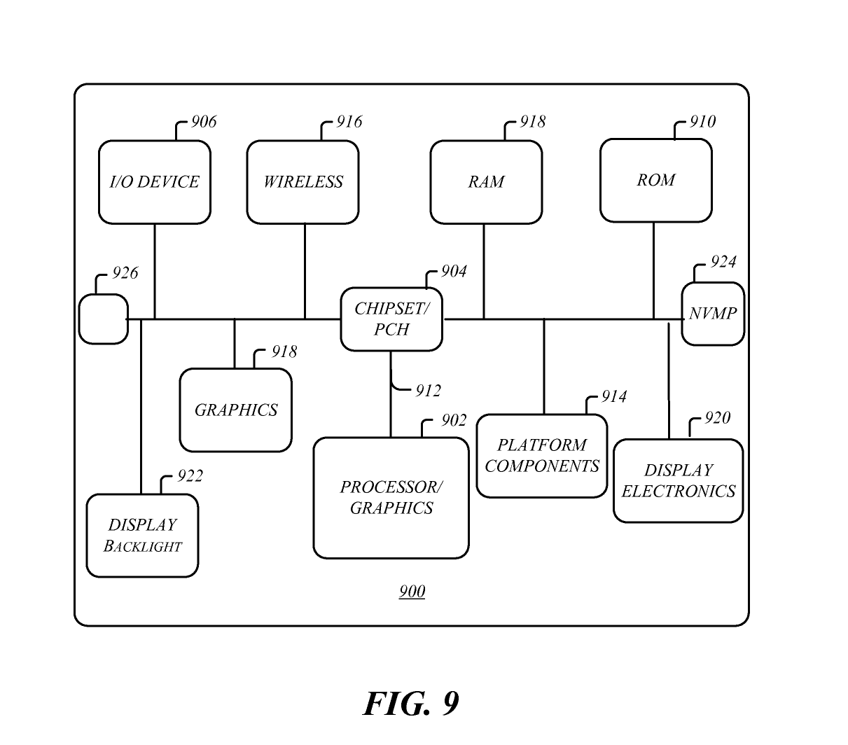

FIG. 9 depicts a diagram of an exemplary system embodiment and in particular, FIG. 9 is a diagram showing a platform 900, which may include various elements. For instance, FIG. 9 shows that platform (system) 900 may include a processor/graphics core 902, a chipset/platform control hub (PCH) 904, an input/output (I/O) device 906, a random access memory (RAM) (such as dynamic RAM (DRAM)) 908, and a read only memory (ROM) 910, display electronics 920, display backlight 922, and various other platform components 914 (e.g., a fan, a crossflow blower, a heat sink, DTM system, cooling system, housing, vents, and so forth). System 900 may also include wireless communications chip 916 and graphics device 918. The embodiments, however, are not limited to these elements.

As shown in FIG. 9, I/O device 906, RAM 908, and ROM 910 are coupled to processor 902 by way of chipset 904. Chipset 904 may be coupled to processor 902 by a bus 912. Accordingly, bus 912 may include multiple lines.

Processor 902 may be a central processing unit comprising one or more processor cores and may include any number of processors having any number of processor cores. The processor 902 may include any type of processing unit, such as, for example, CPU, multi-processing unit, a reduced instruction set computer (RISC), a processor that have a pipeline, a complex instruction set computer (CISC), digital signal processor (DSP), and so forth. In some embodiments, processor 902 may be multiple separate processors located on separate integrated circuit chips. In some embodiments processor 902 may be a processor having integrated graphics, while in other embodiments processor 902 may be a graphics core or cores.

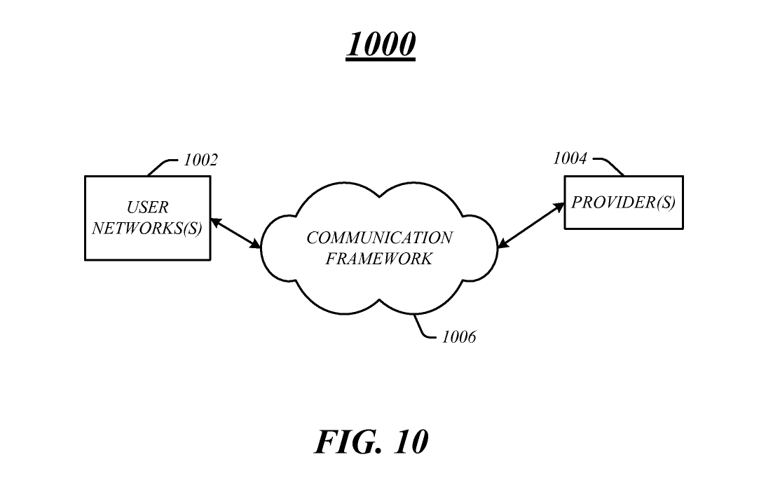

FIG. 10 illustrates a block diagram of an exemplary communications architecture 1000 suitable for implementing various embodiments as previously described. The communications architecture 1000 includes various common communications elements, such as a transmitter, receiver, transceiver, radio, network interface, baseband processor, antenna, amplifiers, filters, and so forth. The embodiments, however, are not limited to implementation by the communications architecture 1000.

As shown in FIG. 10, the communications architecture 1000 comprises includes one or more user networks 1002 and providers 1004.

The user networks 1002 and the providers 1004 may communicate information between each other using a communication framework 1006. The communications framework 1006 may implement any well-known communications techniques and protocols, such as those described with reference to system 100. The communications framework 1006 may be implemented over a combination of wired and wireless links as a packet-switched network, a circuit-switched network (e.g., the public switched telephone network), or a combination of a packet-switched network and a circuit-switched network (with suitable gateways and translators).

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

In one embodiment, an apparatus may include a processor circuit, a memory, and a networking stack for execution on the processor circuit to generate a request message to establish a communications session, the request message including a first globally unique identifier (GUID) that identifies a source device and second GUID associated with a target device, to generate an application identifier that specifies a connection protocol to be used to conduct the communications session, and to initiate the communications session from the source device upon receipt of the second GUID associated with the target device.

In another embodiment, the networking logic may be for execution on the processor circuit to receive an indication that a first transport between the source device and target device has been disrupted, and to provision a second transport different from the first transport for the communications session without terminating the communications session.

Alternatively, or in addition, in a further embodiment, the networking logic may be for execution on the processor circuit to transmit a second application identifier that specifies a second connection protocol to be employed for the communications session.

Alternatively, or in addition, in a further embodiment, the networking stack may be for execution on the processor circuit to employ a transport layer security protocol to exchange security certificate information to be used to initiate the communications session.

Alternatively, or in addition, in a further embodiment, the networking logic may be for execution on the processor circuit to provide with the request message an X.509 security certificate that uniquely identifies the apparatus.

Alternatively, or in addition, in a further embodiment, the networking logic may be for execution on the processor circuit to provide a user social identity, to generate a key pair for sending for verification, and to receive signature of a verified security certificate.

Alternatively, or in addition, in a further embodiment, the networking logic may be for execution on the processor circuit to select one of a multiplicity of different media to transport data over the communications session.

Alternatively, or in addition, in a further embodiment, the networking logic may be for execution on the processor circuit to set a cloud based transport for conducting the communications session.

Alternatively, or in addition, in a further embodiment, the apparatus may include a digital display to present results of data exchanged during the communications session.

In another embodiment, a computer implemented method may include generating a request message to establish a communications session, where the request message includes a first globally unique identifier (GUID) that identifies a source device and a second GUID associated with a target device, supplying an application identifier that specifies a connection protocol to be used to conduct the communications session, and initiating the communications session from the source device upon receipt of the second GUID associated with the target device.

In a further embodiment, the computer implemented method may include receiving an indication that the transport between the source device and target device has been disrupted, and provisioning a second transport different from the first transport for the communications session without terminating the communications session.

Alternatively, or in addition, in a further embodiment the computer implemented method may include transmitting a second application identifier that specifies a second connection protocol to be employed for the communications session.

Alternatively, or in addition, in a further embodiment the computer implemented method may include employing a transport layer security protocol to exchange security certificate information to be used to initiate the communications session.

Alternatively, or in addition, in a further embodiment the computer implemented method may include providing with the request message an X.509 security certificate comprising a serial number that uniquely identifies the source device.

Alternatively, or in addition, in a further embodiment the computer implemented method may include providing a user social identity, generating a key pair for sending for verification, and receiving signature of a verified security certificate.

Alternatively, or in addition, in a further embodiment the computer implemented method may include selecting one of a multiplicity of different media to transport data over the communications session.

Alternatively, or in addition, in a further embodiment the computer implemented method may include setting a cloud based transport for conducting the communications session.

In a further embodiment, an apparatus may be configured to perform the method of any one of the preceding embodiments.

In another embodiment, at least one machine readable medium may comprise a plurality of instructions that in response to being executed on a computing device, cause the computing device to carry out a method according to any one of the preceding embodiments.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a computer-readable medium or article which may store an instruction or a set of instructions that, if executed by a computer, may cause the computer to perform a method and/or operations in accordance with the embodiments. Such a computer may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

What is claimed is:

1. An apparatus, comprising:
a processor circuit; and
networking logic for execution on the processor circuit to:
generate a request message to establish a communications session, the request message including a first globally unique identifier (GUID) that identifies a source device and a second GUID associated with a target device;
generate an application identifier that specifies a connection protocol to be used to conduct the communications session; and
initiate the communications session from the source device upon receipt of the second GUID associated with the target device.

2. The apparatus of claim 1, the networking logic for execution on the processor circuit to:
receive an indication that a first transport between the source device and the target device has been disrupted; and
provision a second transport different from the first transport for the communications session without terminating the communications session.

3. The apparatus of claim 2, the networking logic for execution on the processor circuit to transmit a second application identifier that specifies a second connection protocol to be employed for the communications session.

4. The apparatus of claim 1, the networking logic for execution on the processor circuit to employ a transport layer security protocol to exchange security certificate information to be used to initiate the communications session.

5. The apparatus of claim 1, the networking logic for execution on the processor circuit to provide with the request message an X.509 security certificate that uniquely identifies the source device.

6. The apparatus of claim 1, the networking logic for execution on the processor circuit to:
provide a user social identity;
generate a key pair for sending for verification; and
receive signature of a verified security certificate.

7. The apparatus of claim 1, the networking logic for execution on the processor circuit to select one of a multiplicity of different media to transport data over the communications session.

8. The apparatus of claim 1, the networking logic for execution on the processor circuit to set a cloud based transport for conducting the communications session.

9. The apparatus of claim 1, comprising a digital display to present results of data exchanged during the communications session.

10. At least one computer-readable storage medium comprising instructions that, when executed, cause a system to:
generate a request message to establish a communications session, the request message including a first globally unique identifier (GUID) that identifies a first device and second GUID associated with a second device;
generate an application identifier that specifies a connection protocol to be used to conduct the communications session; and
initiate the communications session upon receipt of the second GUID associated with the second device.

11. The at least one computer-readable storage medium of claim 10, comprising instructions that, when executed, cause a system to:
receive an indication that a first transport between the first device and the second device has been disrupted; and
provision a second transport different from the first transport for the communications session without terminating the communications session.

12. The at least one computer-readable storage medium of claim 10, comprising instructions that, when executed, cause a system to transmit a second application identifier that specifies a second connection protocol to be employed for the communications session.

13. The at least one computer-readable storage medium of claim 10, comprising instructions that, when executed, cause a system to employ a transport layer security protocol to send security certificate information to be used to initiate the communications session.

14. The at least one computer-readable storage medium of claim 10, comprising instructions that, when executed, cause a system to provide with the request message an X.509 security certificate comprising a serial number that provides unique identification.

15. The at least one computer-readable storage medium of claim 10, comprising instructions that, when executed, cause a system to:
provide a user social identity;
generate a key pair for sending for verification; and
receive signature of a verified security certificate.

16. The at least one computer-readable storage medium of claim 10, comprising instructions that, when executed, cause a system to select one of a multiplicity of different media to transport data over the communications session.

17. The at least one computer-readable storage medium of claim 10, comprising instructions that, when executed, cause a system to set a cloud based transport for conducting the communications session.

18. A computer implemented method, comprising:
generating a request message to establish a communications session, the request message including a first globally unique identifier (GUID) that identifies a source device and a second GUID associated with a target device;
supplying an application identifier that specifies a connection protocol to be used to conduct the communications session; and
initiating the communications session from the source device upon receipt of the second GUID associated with the target device.

19. The computer implemented method of claim 18, comprising:
receiving an indication that a first transport between the source device and target device has been disrupted; and
provisioning a second transport different from the first transport for the communications session without terminating the communications session.

20. The computer implemented method of claim 18, comprising transmitting a second application identifier that specifies a second connection protocol to be employed for the communications session.

21. The computer implemented method of claim 18, comprising employing a transport layer security protocol to exchange security certificate information to be used to initiate the communications session.

22. The computer implemented method of claim 18, comprising providing with the request message an X.509 security certificate comprising a serial number that uniquely identifies the source device.

23. The computer implemented method of claim 18, comprising:
providing a user social identity;
generating a key pair for sending for verification; and
receiving signature of a verified security certificate.

24. The computer implemented method of claim 18, comprising selecting one of a multiplicity of different media to transport data over the communications session.

25. The computer implemented method of claim 18, comprising setting a cloud based transport for conducting the communications session.
